(19) United States
(12) Patent Application Publication
(10) Pub. No.: US 2007/0247544 A1
(43) Pub. Date: Oct. 25, 2007

(54) Display control apparatus, display control method and recording medium that stores display control program

(75) Inventor: Keiichi Imamura, Hamura-shi (JP)

Correspondence Address: FRISHAUF, HOLTZ, GOODMAN & CHICK, PC, 220 Fifth Avenue, 16TH Floor, NEW YORK, NY, 10001-7708, US

(73) Assignee: CASIO COMPUTER CO., LTD., Tokyo (JP)

(21) Appl. No.: 11/788,357

(22) Filed: Apr. 19, 2007

(30) Foreign Application Priority Data
Apr. 25, 2006 (JP) 2006-120034

(51) Int. Cl. H04N 5/238

(52) U.S. Cl. 348/366

(57) ABSTRACT

In a digital camera 1, multiple graphic parameter tables in which environmental brightness values (LV) corresponding to the display mode and multiple graphic parameters such as on illumination brightness have been stored in a memory 12. Next, the graphic parameters corresponding to the acquired LV and the display mode that has been set are read out from the memory 12 so as to adjust the illumination brightness of the illumination section 16 of the image display section 15. Furthermore, the images are displayed based on the parameters such as on a brightness level, a contrast level, a saturation level and a sharpness level.

### CROSS-REFERENCE TO RELATED APPLICATION

This application is based upon and claims the benefit of priority from the prior Japanese Patent Application No. 2006-120034, filed Apr. 25, 2006, the entire contents of which is incorporated herein by reference.

### BACKGROUND OF THE INVENTION

1. Field of the Invention

The present invention relates to a display control apparatus and a display control method. Specifically, it relates to a display control apparatus and a display control method for adjusting a display quality when displaying an image, and to a computer-readable storage medium having a display control program stored thereon that is executable by a computer.

2. Description of the Related Art

Recently, in an art to adjust display brightness of the display section where an image or the like is displayed, an art to automatically adjust brightness (display brightness) of a liquid crystal display in accordance with ambient brightness has appeared (for example, refer to Japanese Patent Laid-open Publication No. 2002-344598).

However, the art as described above merely automatically adjusts display brightness in accordance with ambient brightness. Therefore, there are drawbacks where colors of the displayed image are unnatural or a highly defined image cannot be displayed depending of the display brightness.

### SUMMARY OF THE INVENTION

The present invention was achieved in light of the foregoing issues, and an object of the present invention is to provide a display control apparatus and a display control method that can prevent display with unnatural color or lack of high definition while taking into consideration ambient brightness, and a recording medium that stores a display control program.

In accordance with an aspect of the present invention, there is provided a display control apparatus comprising: a display section; a brightness value acquisition section which acquires a brightness value of an ambient environment; a first adjustment section which adjusts a display brightness of the display section in accordance with the brightness value acquired by the brightness value acquisition section; a second adjustment section which adjusts a parameter related to a display property of the display section in accordance with the brightness value acquired by the brightness value acquisition section; and a display control section which controls the display section so as to display an object to be displayed based on the display brightness adjusted by the first adjustment section and the parameter adjusted by the second adjustment section.

In accordance with another aspect of the present invention, there is provided a display control method for displaying an object to be displayed to a display section comprising: a brightness value acquisition step for acquiring a brightness value of an ambient environment; a first adjustment step for adjusting a display brightness of the display section in accordance with the brightness value acquired by the brightness value acquisition step; a second adjustment step for adjusting a parameter related to a display property of the display section in accordance with the brightness value acquired by the brightness value acquisition step; and a display control step for controlling the display section so as to display the object to be displayed based on the display brightness adjusted by the first adjustment step and the parameter adjusted by the second adjustment step.

In accordance with another aspect of the present invention, there is provided a computer-readable storage medium having a display control program stored thereon that is executable by a computer for displaying an object to be displayed to a display section, comprising: a brightness value acquisition step for acquiring a brightness value of an ambient environment; a first adjustment step for adjusting a display brightness of the display section in accordance with the brightness value acquired by the brightness value acquisition step; a second adjustment step for adjusting a parameter related to a display property of the display section in accordance with the brightness value acquired by the brightness value acquisition step; and a display control step for controlling the display section so as to display the object to be displayed based on the display brightness adjusted by the first adjustment step and the parameter adjusted by the second adjustment step.

The above and further objects and novel features of the present invention will more fully appear from the following detailed description when the same is read in conjunction with the accompanying drawings. It is to be expressly understood, however, that the drawings are for the purpose of illustration only and are not intended as a definition of the limits of the invention.

### BRIEF DESCRIPTION OF THE DRAWINGS

FIG. 1A is a block diagram of a digital camera 1 in an embodiment of the present invention;

FIG. 1B is a chart showing contents stored in a setting table 1201;

FIG. 2 is a flowchart showing an operation of the digital camera 1 according to the first embodiment;

FIG. 3A is a chart showing data of a graphic parameter table 121 when the display mode is “REAL”;

FIG. 3B is a graph showing the relation among each parameter in the graphic parameter table 121;

FIG. 4A is a chart showing data of a graphic parameter table 122 when the display mode is “DYNAMIC”;

FIG. 4B is a graph showing the relation among each parameter in the graphic parameter table 122;

FIG. 5A is a chart showing data of a graphic parameter table 123 when the display mode is “VIVID”,

FIG. 5B is a graph showing the relation among each parameter in the graphic parameter table 123;

FIG. 6A is a chart showing data of a graphic parameter table 124 when the display mode is “NIGHT”;

FIG. 6B is a graph showing the relation among each parameter in the graphic parameter table 124;

FIG. 7A is a chart showing data of a graphic parameter table 125 when the display mode is “POWER SAVING”;

FIG. 7B is a graph showing the relation among each parameter in the graphic parameter table 125;

FIG. 8 is a flowchart showing an operation of the digital camera 1 according to the second embodiment;

FIG. 9 is a block diagram of the digital camera 1 according to a third embodiment;

FIG. 10 is a flowchart showing an operation of the digital camera 1 according to the third embodiment;

FIG. 11A is a chart showing data of graphic parameters on brightness in a graphic parameter table 123′ when the display mode is “VIVID”;

FIG. 11B is a graph showing the relation among each parameter in the graphic parameter table 123′;

FIG. 12 is a flowchart showing an operation of the digital camera 1 according to the fourth embodiment;

FIG. 13 is a block diagram of the digital camera 1 in a modification;

FIG. 14A is a chart showing data of a brightness parameter table 126 storing illumination brightness for each display mode;

FIG. 14B is a graph showing the relation among each parameter in the brightness parameter table 126;

FIG. 15A is a chart showing data of a brightness level parameter table 127 storing brightness levels for each display mode;

FIG. 15B is a graph showing the relation among each parameter in the brightness level parameter table 127;

FIG. 16A is a chart showing data of a contrast level parameter table 128 storing contrast levels for each display mode;

FIG. 16B is a graph showing the relation among each parameter in the contrast level parameter table 128;

FIG. 17A is a chart showing data of a saturation level parameter table 129 storing saturation levels for each display mode; and

FIG. 17B is a graph showing the relation among each parameter in the saturation level parameter table 129.

### DETAILED DESCRIPTION OF THE PREFERRED EMBODIMENTS

Hereinafter, the preferred embodiments of the present invention will be described with reference to the drawings as an example of application of a display control apparatus of the present invention to a digital camera.

### A. First Embodiment

A-1. Configuration of Digital Camera

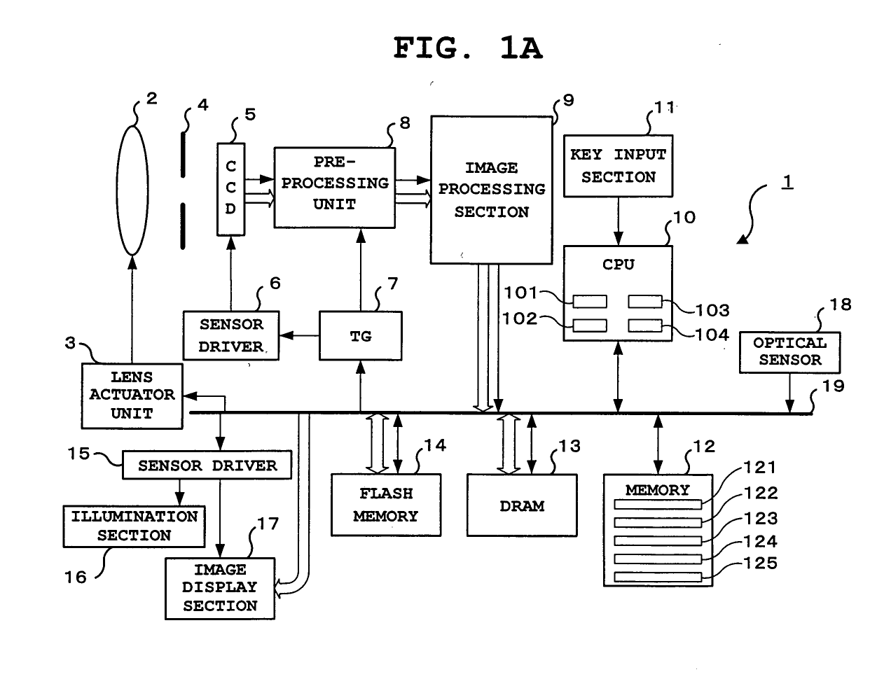

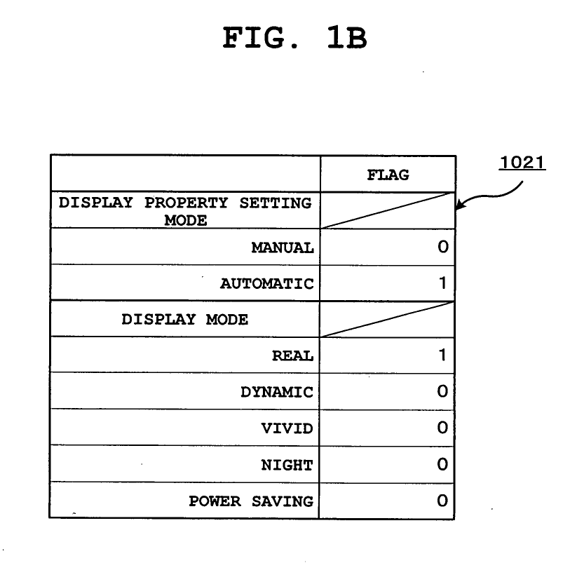

FIG. 1A is a block diagram showing the general electrical outline configuration of a digital cameral 1 as an image display apparatus and imaging apparatus which realizes the display control apparatus according to the present invention.

The digital camera 1 includes a lens unit 2, a lens actuator unit 3, an aperture 4, a CCD 5, a sensor driver 6, a timing generator (TG) 7, a pre-processing unit 8, an image processing section 9, a CPU 10, a key input section 11, a memory 12, a dynamic random access memory (DRAM) 13, a flash memory 14, a sensor driver 15, an illumination section 16, an image display section 17, a sensor 18 and a bus 19.

The lens unit 2, the lens actuator unit 3, the aperture 4 and the CCD 5 constitute imaging means.

The lens unit 2 includes a focus lens and a zoom lens, not shown, and is connected to the lens actuator unit 3. The lens actuator unit 3 is configured with a focus motor and a zoom motor for driving the focus lens and the zoom lens, not shown, respectively in the optical axis direction, and a focus motor driver and a zoom motor driver for driving the focus motor and the zoom motor in accordance with a control signal from the CPU 10.

The aperture 4 includes a drive circuit, not shown, and the drive circuit operates the aperture 4 in accordance with the control signal which has been sent by the CPU 10.

The aperture refers to a mechanism that controls quantity of incident light from the lens unit 2.

An imaging element (the CCD 5, herein) is driven by the sensor driver 6, photo-electrically converts the intensity of light of the respective colors in RGB values of an object image at certain time intervals and outputs it to the pre-processing unit 8 as the imaging signals. The operation timing of the sensor driver 6 and the pre-processing unit 8 is controlled by the CPU 10 via the TG 7. Note that the CCD 5 has a color filter of the Bayer arrangement, and has the function as the electronic shutter. The shutter speed of the electronic shutters is controlled by the CPU 10 via the sensor driver 6 and the TG 7.

The pre-processing unit 8 is configured with a correlated double sampling (CDS) circuit for performing correlated double sampling of imaging signals that are outputted from the CCD 5 and holding them, an automatic gain control (AGC) circuit for performing automatic gain control of the sampled imaging signals, and an analog to digital (A/D) converter for converting the automatic-gain-controlled analog signals. The imaging signals of the CCD 5 are sent as digital signals to the image processing section 9 via the pre-processing unit 8.

The image processing section 9 performs processing such as γ compensation processing and white balance processing to the image data which has been sent from the pre-processing unit 8, and generates luminosity color difference signals (YUV data). The thus generated luminosity color difference signal data is stored in the buffer memory (DRAM 13). In other words, the image processing section 9 performs image processing to the image data outputted by the CCD 5 and performs processing of converting it to luminosity color difference signals.

The CPU 10 is a one-chip microcomputer with functions of compression and expansion (for example, in Joint Photographic Experts Group (JPEG) format or Moving Picture Experts Group (MPEG) format) processing, recording processing, and replay processing, which controls each section of the digital camera 1. Particularly, the CPU 10 includes an environmental brightness acquisition circuit 101, a mode setting circuit 102, a display adjustment circuit 103 and an estimation circuit 104.

The environmental brightness acquisition circuit 101 acquires a brightness value of an ambient environment based on brightness components of the image data which has been picked up.

The mode setting circuit 102 has a setting table as shown in FIG. 1B.

The display adjustment circuit 103 performs adjustment processing of a degree of display illumination, a brightness level, a contrast level and a saturation level based on a display property that has been set and detected environmental brightness.

The estimation circuit 104 estimates “what image is displayed” in the image that has been picked up based on color components and bias thereof.

FIG. 1B shows the contents of the setting table 1021 contained in the mode setting circuit 102. In the setting table 1021, whether the display property setting mode that is currently being set is “AUTOMATIC” or “MANUAL”, and whether the display mode is “REAL”, “DYNAMIC”, “VIVID”, “NIGHT” or “POWER SAVING” are storage managed using a flag. The display property setting mode and the display mode will be explained later.

The key input section 11 includes multiple operation keys, such as a power On/Off key, a shutter button, a mode selection key, a plus key, a SET key, and finder brightness adjustment buttons (a “+” button and a “−” button) and the like, and outputs operation signals corresponding to a key operation by a user to the CPU 10.

A program that is necessary for control of each section of the digital camera 1 by the CPU 10 and data that is necessary for control of each section are stored in the memory 12 (storage means), and the CPU 10 performs each processing in accordance with the programs.

The CPU 10 realizes functions as brightness value acquisition means, first adjustment means, second adjustment means, selection means, first adjustment control means, second adjustment control means, third adjustment control means, forth adjustment control means, first selection control means, first acquisition control means, second acquisition control means, display control means, and estimation means.

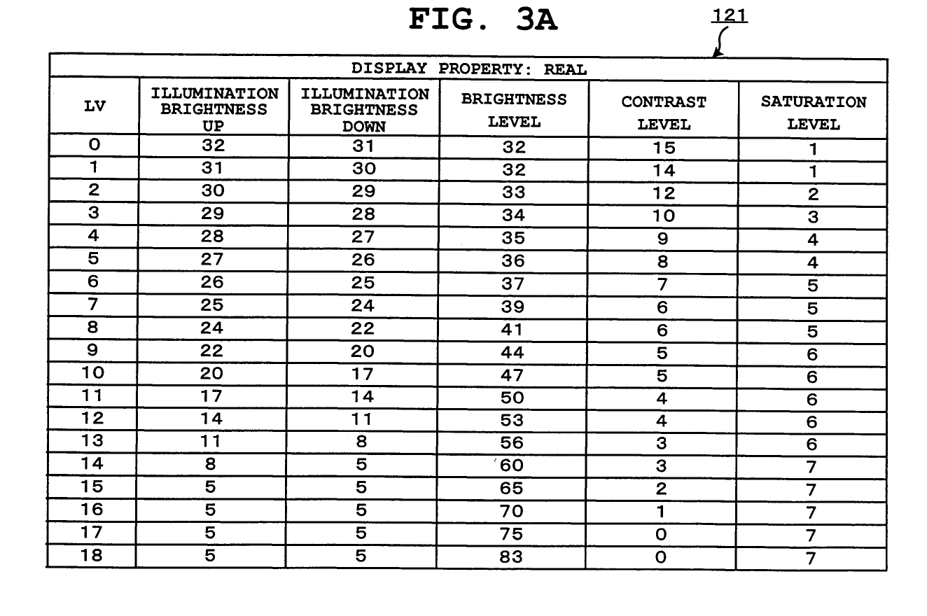

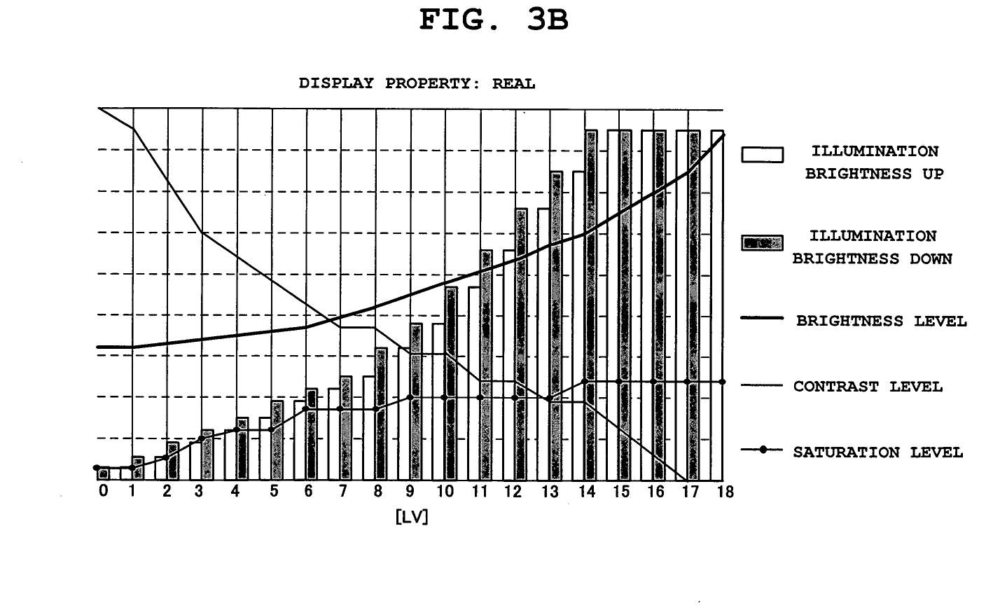

Furthermore, the memory 12 includes individual graphic parameter tables 121 to 125 as shown in FIGS. 3A, 3B to FIGS. 7A, 7B. The graphic parameters herein include not only a parameter with which the sensor driver 15 adjusts the brightness of the illumination section 16 for illuminating the image display section 17 from the back, but also parameters for adjusting the brightness level, the contrast level and the saturation level of the recorded image to be displayed in the image display section 17.

Note that, for the digital camera 1, 5 parameter tables have been prepared: a parameter table for “REAL” display mode 121, a parameter table for “DYNAMIC” display mode 122, a parameter table for “VIVID” display mode 123, a parameter table for “NIGHT” display mode 124, and a parameter table for “POWER SAVING” display mode 125, which will be explained later.

The DRAM 13 is used as a buffer memory to temporarily store the image data picked up by the CCD 5 and sent to the CPU 10, and also as a working memory of the CPU 10. The flash memory 14 is a record medium for storing image data which is picked up by the CCD 5 and compressed by the CPU 10.

The illumination section 16 (illumination means) illuminates light from the back of the image display section 17, and the image display section 17 (display means) displays the image based on the image data. The sensor driver 15 adjusts the brightness of the illumination section 16 which illuminates the image display section 17 from the back (the opposite side of the display surface) in accordance with a control signal for the CPU 10, and controls driving of the image display section 17. An optical sensor 18 is a sensor for acquiring ambient brightness. In FIG. 1A, a thin arrow shows the flow of a signal and a bold arrow shows the flow of image data.

A-2. Operation of Digital Camera 1

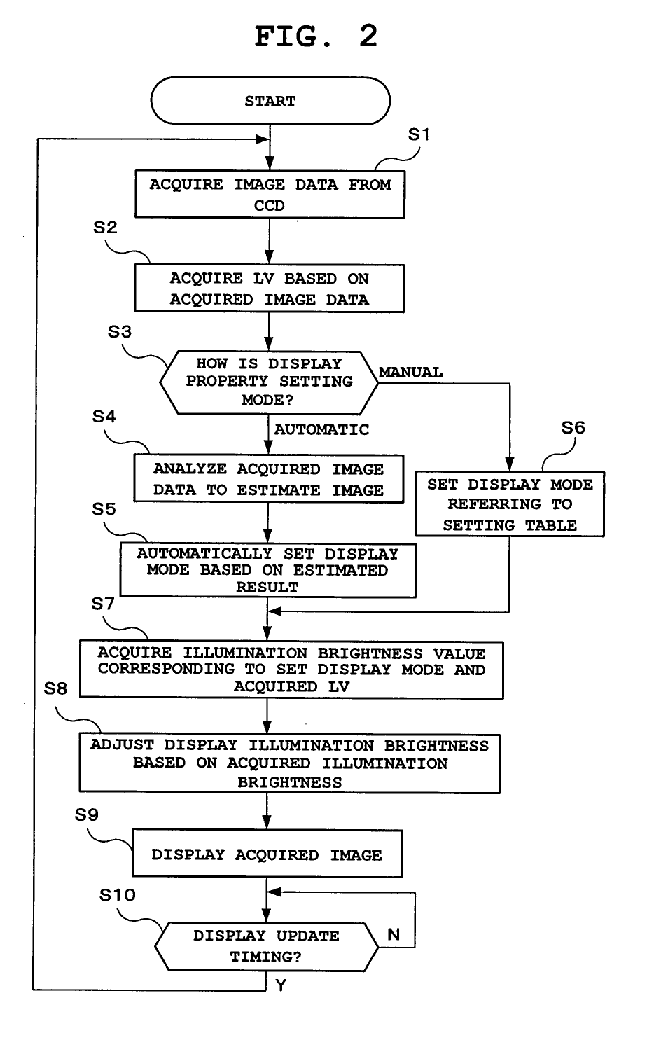

The operation of the digital camera 1 in the first embodiment will be explained according to the flowchart in FIG. 2.

When the mode is set to a still image recording mode or a movie recording mode by operation of the mode selection key of the key input section 11 by the user, and then through image display or movie recording is started (that is, when the mode has become a mode for displaying the picked-up image data), the CPU 10 at Step S1 acquires a piece of most recent image data (YUV data) that has been picked up by the CCD 5 and generated by the image processing section 9 from the buffer memory (DRAM 13).

Next, at Step S2, the CPU 10 causes the environmental brightness acquisition circuit 101 to acquire an environmental brightness value from brightness components of the acquired image data. Since the method of acquiring the environmental brightness value is known, explanation thereof is omitted. Note that an environmental brightness value may be acquired based on brightness components acquired by the optical sensor 18 provided separately from the CCD 5. This enables acquiring the ambient brightness.

Next, by referring to the status of each flag in the setting table 1021 of the mode setting circuit 102, the CPU 10 judges whether the display property setting mode has been set to “AUTOMATIC” by operation of the key input section 11 by the user or the like, that is, whether the flag has been set to “AUTOMATIC” in the display property setting mode (Step S3). Note that when the display property setting mode has been set to “AUTOMATIC”, the display mode will be automatically set by estimation processing by the estimation circuit 104 to be explained later.

Meanwhile, the user can set the display property setting mode to “AUTOMATIC” or “MANUAL” in advance. For doing this, the mode setting circuit 102 sets flag “1” to either “AUTOMATIC” or “MANUAL” of the display property setting mode stored in the setting table 1021 based on the setting operation by the user. When “MANUAL” has been set, the user manually selects the display mode. Types of the display mode are “DYNAMIC”, “VIVID”, “REAL”, “NIGHT” and “POWER SAVING”. The mode setting circuit 102 sets the flag “1” to one of the display modes “REAL”, “DYNAMIC”, “VIVID”, “NIGHT” or “POWER SAVING” to be stored in the setting table 1021 based on the setting operation by the user. Although the five types are employed as the display mode, the display mode is not limited to these types and other types may be used. Furthermore, the digital camera can be set such that the user may set the display property setting mode to “AUTOMATIC” or “MANUAL” during the still image recording mode or the movie recording mode.

If judged at Step S3 that “AUTOMATIC” has been set, the CPU 10 advances to Step S4 where it causes the estimation circuit 104 to acquire from the whole area color components (RGB) of pixels in the image data (YUV data) acquired at Step S1, and to estimate “what image is displayed” for the image to be displayed based on what color is used most or bias of a specific color in the whole area of the image data.

The estimation circuit 104 estimates an image as follows. For example, the estimation circuit 104 analyses what color is used most in the acquired image data. If flesh color components are dominating, the estimation circuit 104 estimates the image data as “photograph of a person”, and if the environmental brightness value detected at Step S2 is low and low detected levels are observed for all color components, it estimates the image contents as a “night view”. Furthermore, if the environmental brightness value detected at Step S2 is high, and more blue (component B) and green (component G) are included in the color components of pixels (RGB), the estimation circuit 104 estimates the image contents as “photograph of a landscape recorded in fine weather” or “photograph of flowers recorded in fine weather”.

Next, at Step S5, the CPU 10 selects the most suitable display mode based on the result of estimation by the estimation circuit 104. After the selection, the CPU 10 controls the mode setting circuit 102 so as to change the flag status of the display mode in the setting table 1021, and advances to Step S7. When specifically explaining this based on the result of estimation by the estimation circuit 104, when the image content is estimated as “photograph of a landscape recorded in fine weather”, the CPU 10 sets the display mode to “DYNAMIC”. On the other hand, when the image content is estimated as “photograph of flowers recorded in fine weather”, the CPU 10 sets the display mode to “REAL”. In addition, when the image content is estimated as “night view”, the CPU 10 sets the display mode to “NIGHT”. Meanwhile, if judged at Step S3 that the display property setting mode is “MANUAL”, the CPU 10 advances to Step S6 where the CPU 10 sets the display mode referring to the status of each flag in the setting table 1021 of the mode setting circuit 102, and advances to Step S7.

When the CPU 10 advances to Step S7, the CPU 10 reads out from the memory 12 a graphic parameter (i.e., parameter on display quality) value corresponding to the display mode that has been set and the environmental brightness value acquired at Step S2.

FIGS. 3A, 3B to FIGS. 7A, 7B respectively show the contents of the graphic parameter tables stored in the memory 12 and the relation between the environmental brightness values based on the graphic parameter table and the graphic parameters.

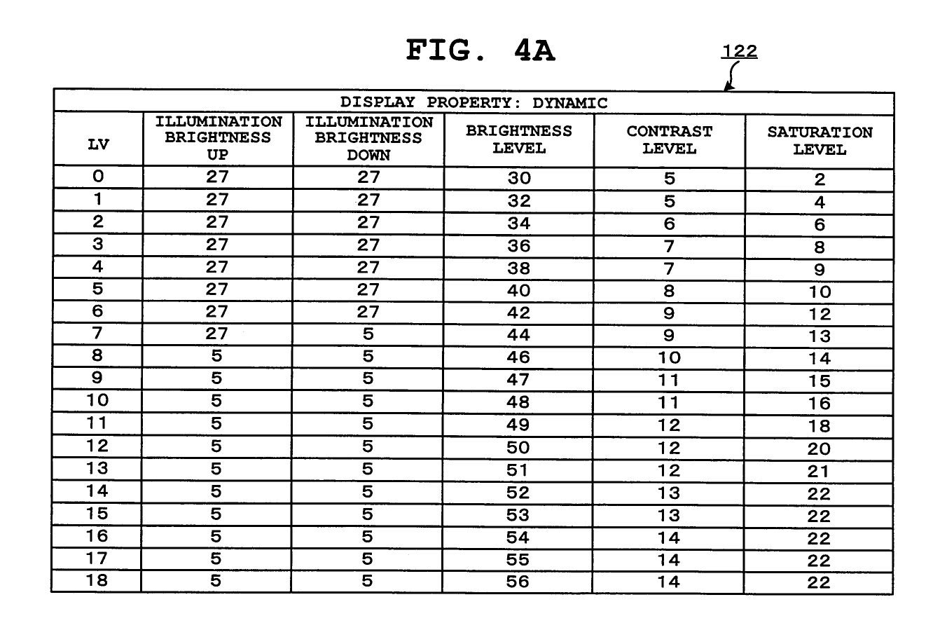

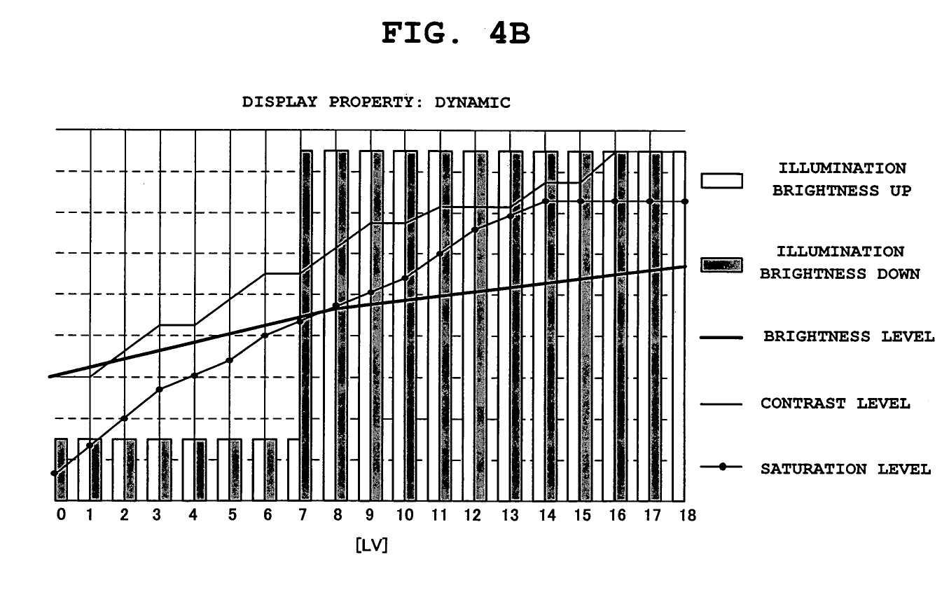

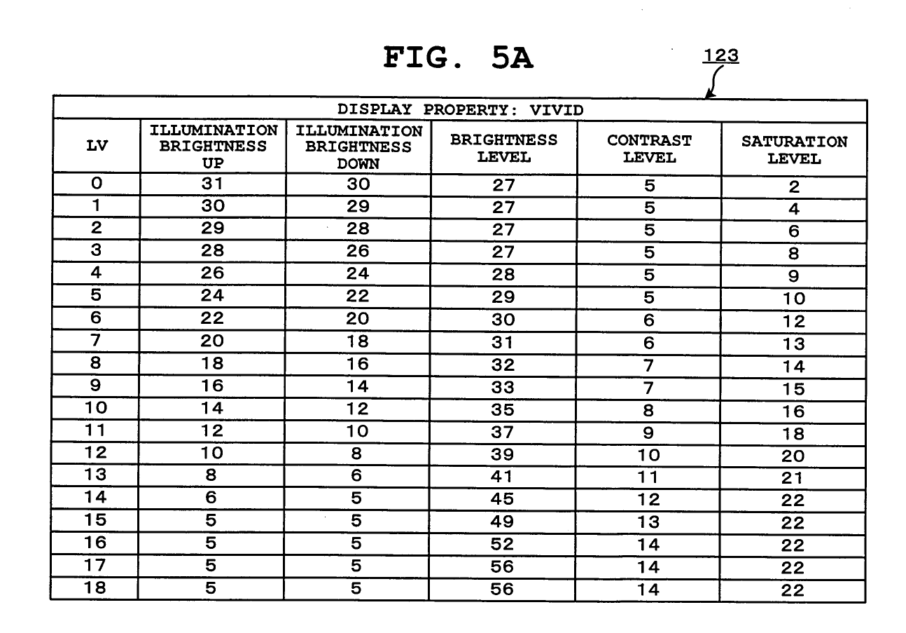

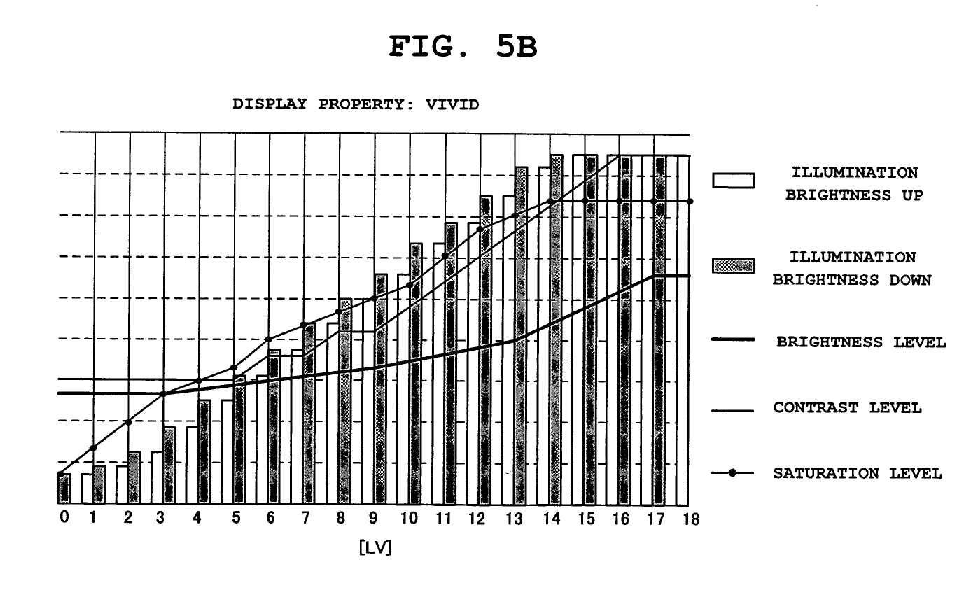

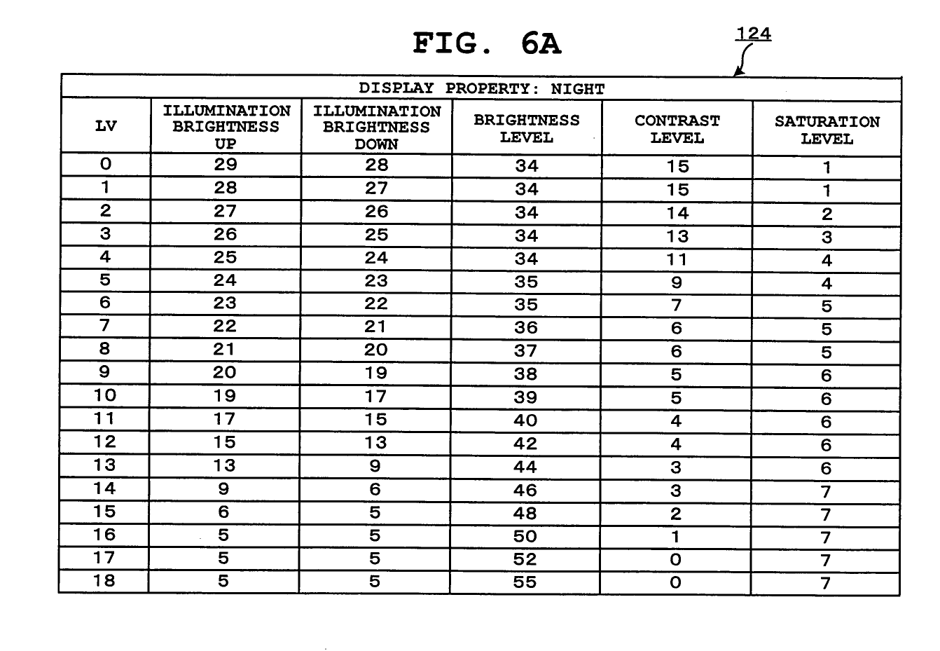

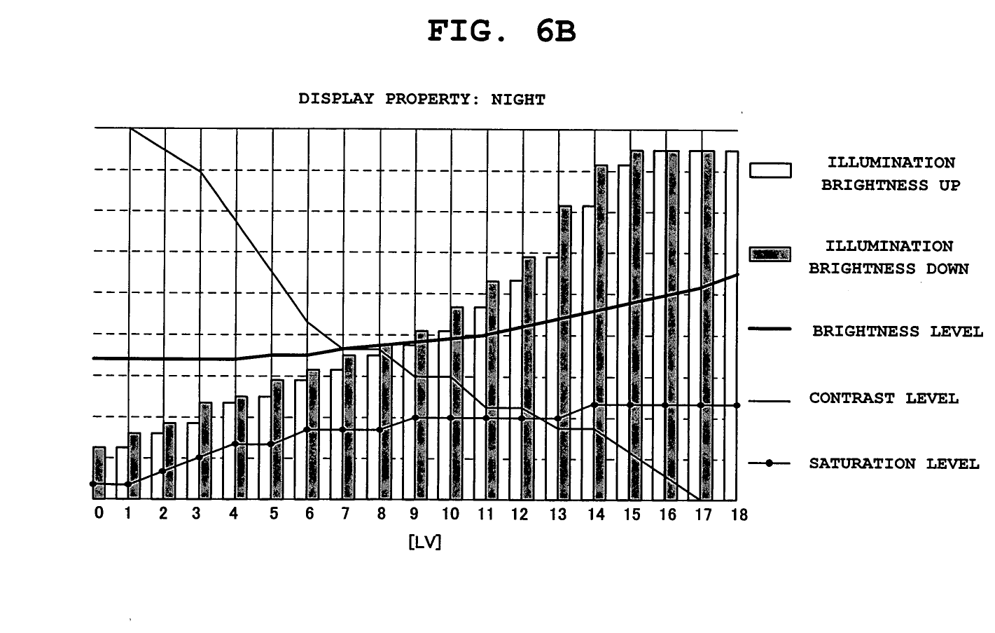

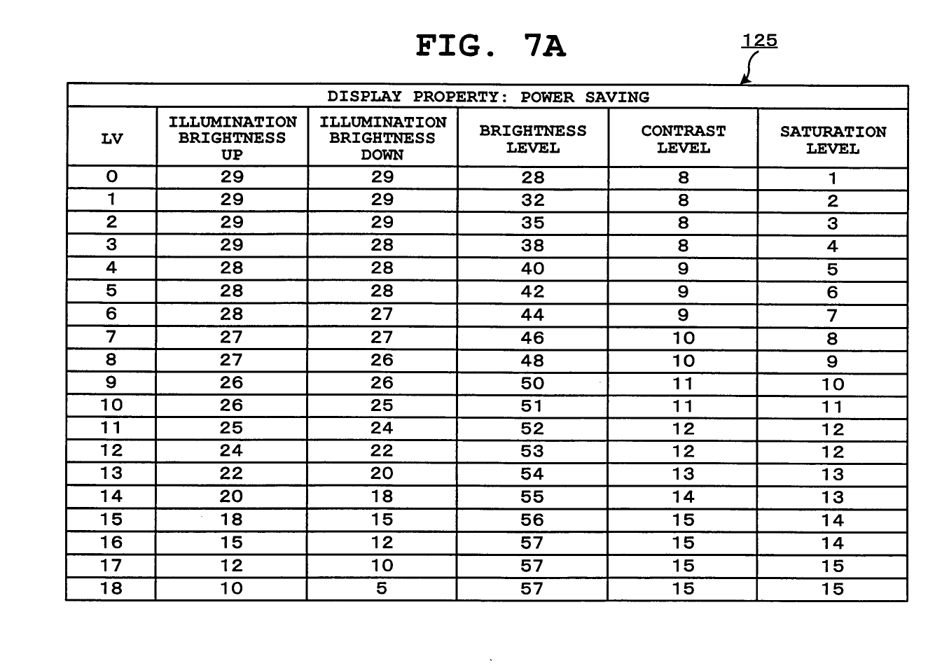

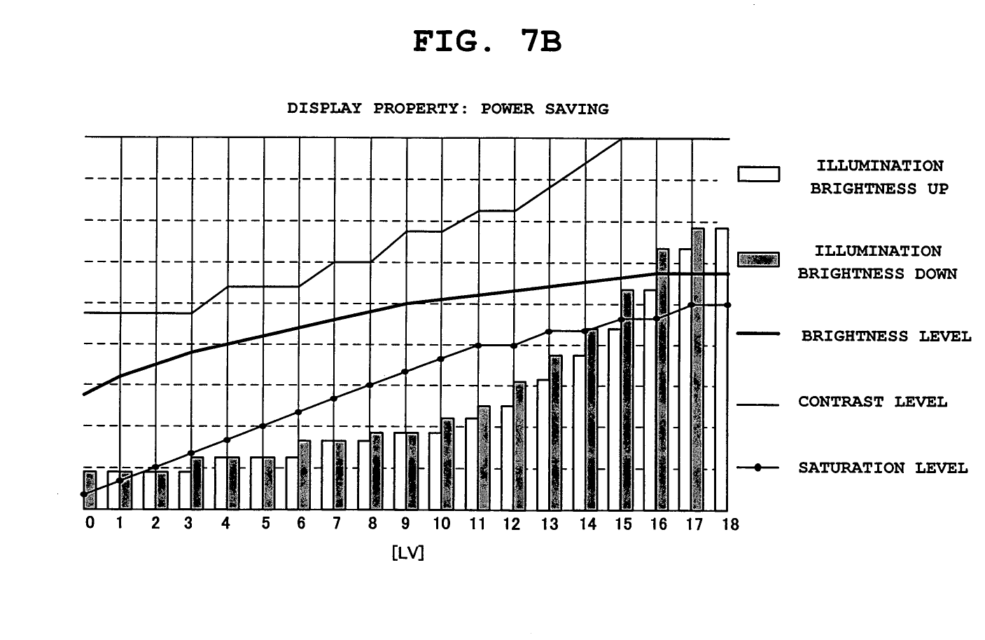

FIGS. 3A and 3B show the contents of the graphic parameter table 121 when the display mode is “REAL” and the relation among them. FIGS. 4A and 4B show the contents of the graphic parameter table 122 when the display mode is “DYNAMIC” and the relation among them. FIGS. 5A and 5B show the contents of the graphic parameter table 123 when the display mode is “VIVID” and the relation among them. FIGS. 6A and 6B show the contents of the graphic parameter table 124 when the display mode is “NIGHT” and the relation among them. FIGS. 7A and 7B show the contents of the graphic parameter table 125 when the display mode is “POWER SAVING” and the relation among them.

In the graphic parameter table 121 as shown in FIG. 3A, parameters on an illumination brightness UP, an illumination brightness DOWN, the brightness level, the contrast level and the saturation level are stored for each environmental brightness value (LV) when the display mode is “REAL”. FIG. 3B shows the relation among them. The “REAL” display mode is a mode considered as the standard for multiple display modes and emphasizes on tone expression of the image to be displayed. The illumination brightness (display brightness) of the illumination section 16 is set as the maximum when the LV is 15 or more. When the LV gets higher than that, the sensor driver 15 controls the image display section 17 so as to make the image easier to see for the user, thereby increasing the parameters on the brightness level. Furthermore, since tone expression is emphasized in the mode, as the LV increases, the sensor driver 16 decreases the parameters on the contrast level, thereby preventing white out and black out of the image to be displayed.

In the graphic parameter table 122 as shown in FIG. 4A, parameters on the illumination brightness UP, the illumination brightness DOWN, the brightness level, the contrast level and the saturation level are stored for each LV when the display mode is “DYNAMIC”. FIG. 4B shows the relation among them. The display “DYNAMIC” mode, with a higher contrast level, is effective for confirmation of the image display section 17 by the user under a bright environment. In that case, the sensor driver 15 sets two-stage illumination brightness (display brightness) to the illumination section 16. Furthermore, since brilliance of the image display section is compensated by illumination by the illumination section 16, the parameter on the brightness level increases more mildly and the parameters on the contrast level and the saturation level increase substantially lineally as the LV increases.

Furthermore, in the graphic parameter table 123 as shown in FIG. 5A, parameters on the illumination brightness UP, the illumination brightness DOWN, the brightness level, the contrast level and the saturation level are stored for each LV when the display mode is “VIVID”. FIG. 5B shows the relation among them. The “VIVID” display mode is an intermediate mode between the above-described “REAL” and “DYNAMIC”, and emphasizes on the color expression capability of the image display section 17. When the illumination brightness (display brightness) of the illumination section 16 is to be adjusted, the illumination brightness is slightly higher than that for “REAL” and increases linearly. On the other hand, the parameter on the brightness level increases slightly more mildly. Furthermore, the parameters on the contrast level increase slightly more mildly compared to above-described “DYNAMIC” as described above, and the same parameters on the saturation level is used as that for above-described “DYNAMIC”.

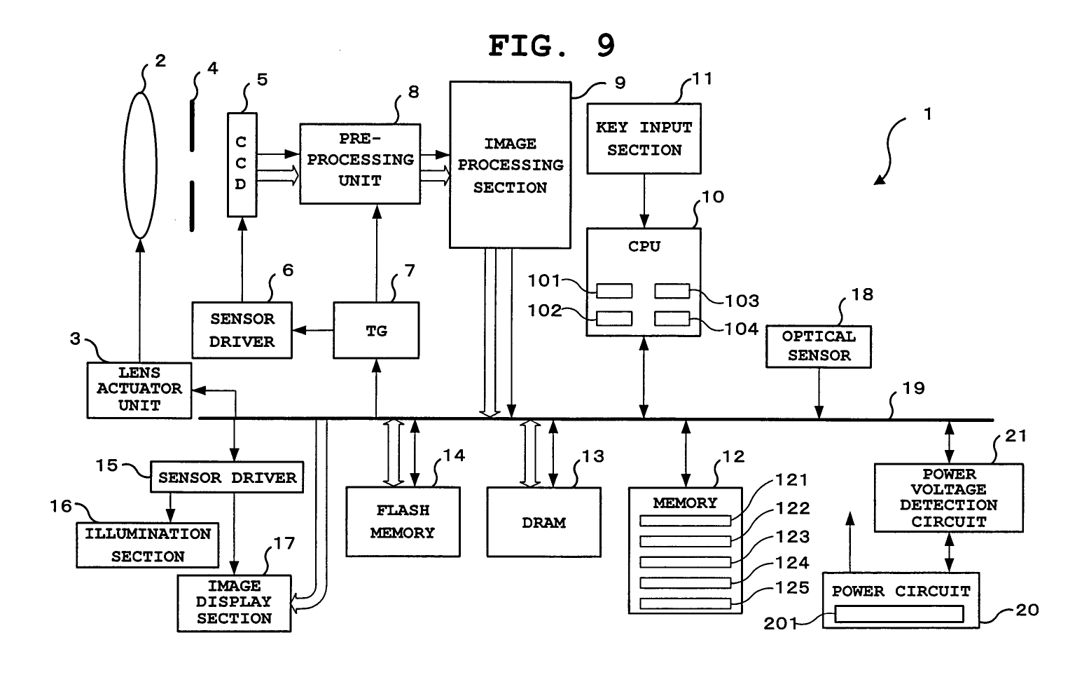

In the graphic parameter table 124 as shown in FIG. 6A, parameters on the illumination brightness UP, the illumination brightness DOWN, the brightness level, the contrast level and the saturation level are stored for each LV when the display mode is “NIGHT”. FIG. 9B shows the relation among them. In the “NIGHT” display mode, the user observing the image display section 17 in a dark place is taken into consideration, and the sensor driver 15 controls the parameters so as to suppress the degree of change in the parameters on the illumination brightness of the illumination section 16 and the brightness level, since eyes of the user are sensitive in responding to the change of the brightness. Furthermore, the sensor driver 15 performs a control so that the change in the parameters on the contrast level and the saturation level is made almost equivalent to that for the above-described “REAL”. Accordingly, control is made so that tone expression capability of the image to be displayed is not suppressed while the display brightness is suppressed.

In the graphic parameter table 125 as shown in FIG. 7A, parameters on the illumination brightness UP, the illumination brightness DOWN, the brightness level, the contrast level and the saturation level are stored for each LV when the display mode is “POWER SAVING”. FIG. 7B shows the relation among them. The POWER SAVING display mode is a mode where the sensor driver 15 performs a control so as to suppress the power consumption of the illumination section 16. The display adjustment circuit 103 performs a control so that the illumination brightness of the illumination section 16 increases more mildly compared to the increase in LV, and the parameters on the brightness level and the contrast level increase so as to compensate darkness of the image. Furthermore, the parameters on the saturation level are controlled at a substantially intermediate value between the above-described “DYNAMIC” & “VIVID” and “REAL” & “NIGHT”. Note that the values indicated in the column of the illumination brightness value stored in the graphic parameter table do not directly indicate the brightness value, but indicate the information on the address of the brightness table storing the brightness values corresponding to each value. In addition, the brightness expressed in the relational graph indicates the brightness value.

Note that the illumination brightness, the brightness level, the contrast level, and the saturation level are used as the graphic parameters in the graphic parameter tables. However, the graphic parameters are not limited to these and other elements (such as a sharpness level) may be added and the number of types of the graphic parameters is not limited to five.

As described above, at Step S7, the CPU 10 acquires multiple types of the graphic parameter values corresponding to the LV detected at Step S2 from the graphic parameter table for the display mode that has been set at Step S5 or Step S6.

Next, the CPU 10 adjusts the property of the image to be displayed (display property) based on the acquired graphic parameters (Step S8), and displays the image acquired at Step S1 (Step S9). In other words, the CPU 10 adjusts the illumination brightness of the illumination section 16 based on the acquired LV, and displays the image based on the image data acquired at Step S1 in accordance with the acquired parameters on the brightness level, the contrast level and the saturation level.

Next, the CPU 10 judges that whether display update timing has come (Step 10). The judgment on whether display update timing has come is made based on whether a frame cycle (i.e., imaging cycle) has come. If judged at Step S10 that display update timing has not come, the CPU 10 stays at Step S10 until the display update timing has come, and if judged that display update timing has come, the CPU 10 returns to Step S1.

As described above, in the first embodiment, when the processing of displaying the image data picked up by the CCD 5 is started, the CPU 10 acquires the picked up image data periodically. Next, the CPU 10 acquires the LV from the acquired image data, and acquires multiple types of the graphic parameters (i.e., parameters on display property) including the display brightness (display illumination brightness) corresponding to the acquired LV and the display mode that has been set from the memory 12. Furthermore, since the image is displayed based on the acquired graphic parameters, while taking into account ambient brightness, unnatural colors and low-definition display can be prevented.

Meanwhile, if the display property setting mode has been set to “AUTOMATIC”, the CPU 10 analyzes the color components of the acquired image data to estimate “what image is displayed” for the image, and sets the display mode based on the estimated result. Therefore, the display mode suitable for the ambient environment and the image which is being rendered (picked up) can be set. On the other hand, if the display property setting mode is “MANUAL”, the CPU 10 sets the display mode to a mode selected by the user. Accordingly, the image can be displayed in the display mode desired by the user.

### B. Second Embodiment

Next, the second embodiment will be explained. In the first embodiment, explanation was given on automatic adjustment of the display property when displaying the image data which has been picked up, such as during the through image display and the movie recording. In the second embodiment, automatic adjustment of the display property is executed when replaying the image data.

B-1. Operation of Digital Camera 1

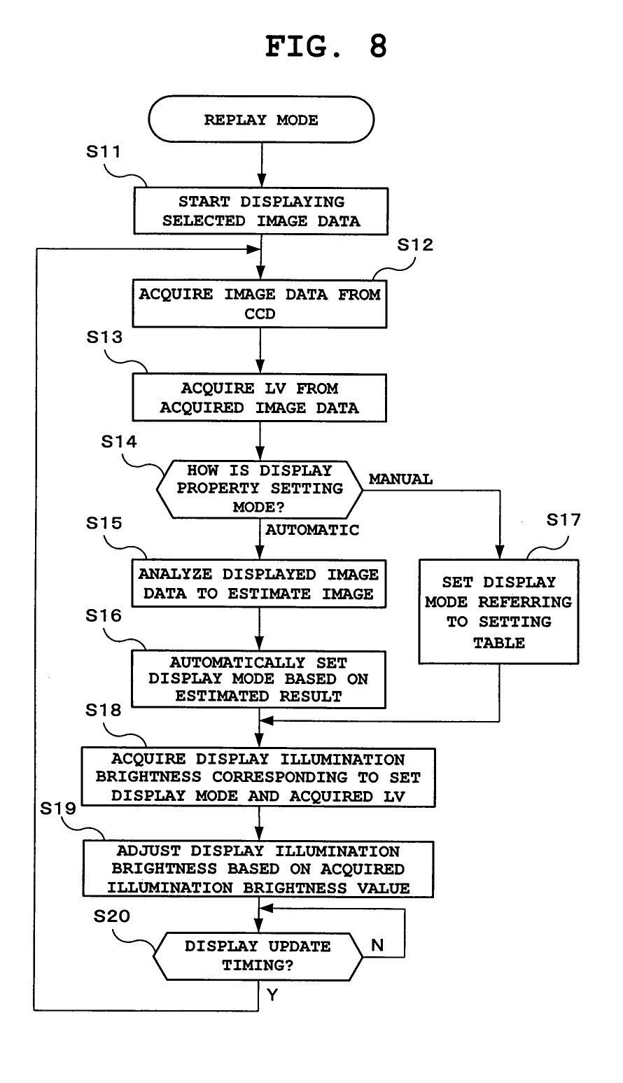

The second embodiment also realizes the imaging apparatus of the present invention by using the digital camera 1 with the same configuration as FIG. 1. Hereinafter, the operation of the digital camera 1 according to the second embodiment will be explained referring to the flowchart in FIG. 8.

When the mode is set to the replay mode by the operation of the selection key by the user and the image data to be displayed is selected, the CPU 10 starts the processing of reading out the selected image data from the flash memory 14 and displaying it in the image display section 15 (Step S11). At this time, if a still image data is selected, a still image is continuously displayed on the image display section 15, and if a movie data is selected, frames are sequentially displayed at certain time intervals starting with the first frame of the movie data.

Next, the CPU 10 causes the CCD 5 to pick up an image to acquire a piece of image data (Step S12). The image data to be acquired is YUV data that underwent image processing by the image processing section 9. Next, the CPU 10 causes the environmental brightness acquisition circuit 101 to acquire the LV from the brightness components of the acquired image data (Step S13). Note that the LV may be detected based on the brightness components acquired by the optical sensor 18 provided separately from the CCD 5. This eliminates the necessity of acquiring the image data by picking it up at Step S12.

Next, by referring to the status of each flag in the setting table 1021 of the mode setting circuit 102, the CPU 10 judges whether the display property setting mode is currently set to “AUTOMATIC” by operation of the key input section 11 by the user or the like, that is, whether the flag has been set to “AUTOMATIC” in the display property setting mode (Step S14).

If judged at Step S14 that the display property setting mode has been set to “AUTOMATIC”, the CPU 10 causes the estimation circuit 104 to acquire color components (RGB) of pixels in the image data (YUV data) acquired at Step S1 from the whole area, and to estimate “what image is displayed” for the image to be displayed based on what color is used most or bias of a specific color in the whole area of the image data (S15). The currently displayed data refers to an image data which is currently displayed when a still image is replayed for display, and refers to image data of a currently-displayed frame or the nearest preceding frame. Next, the CPU 10 sets the display mode based on the estimated image contents (Step S16) and advances to Step S18.

On the other hand, if judged at Step S14 that the display property setting mode has been set to “MANUAL”, the CPU 10 sets the display mode referring to the status of each flag in the setting table 1021 of the mode setting circuit 102 (Step S17), and advances to Step S18. Note that the display property setting mode may be changed to “AUTOMATIC” or “MANUAL” during the replay mode. When the CPU 10 advances to Step S18, it reads out the graphic parameters (such as parameters on the illumination brightness and the brightness level) corresponding to the display mode that has been set and the LV detected at Step S13 from the memory 12.

Next, the CPU 10 adjusts the property of the image to be displayed (display property) based on the acquired graphic parameters (Step S19). In other words, the CPU 10 adjusts the illumination brightness of the illumination section 16 based on the acquired LV, and displays an image based on the image data selected at Step S11 in accordance with the acquired parameters on the brightness level, the contrast level and the saturation level. Next, the CPU 10 judges whether display update timing has come (at Step S20). If judged that display update timing has come, the CPU 10 returns to Step S12. When replaying a movie, the display update timing refers to the frame cycle (i.e., cycle for displaying frames), and when replaying a still image, it refers to a cycle of displaying the still image.

As described above, in the second embodiment, when the CPU 10 displays the image data recorded in the flash memory 14 by replaying it, the CPU 10 causes the CCD 5 to acquire the image data periodically, detects the LV based on the acquired image data, acquires the graphic parameters including the display brightness corresponding to the detected LV and the display mode that has been set from the memory 12, and adjusts the display property of the image to be displayed based on the acquired graphic parameters. Therefore, unnatural colors or low-definition display can be prevented even during display by replaying.

Furthermore, when the display property setting mode has been set to “AUTOMATIC”, the CPU 10 analyzes the color components of the acquired image data to estimate “what image is displayed” for the data, and sets the display mode based on the estimated result. Accordingly, a display mode suitable for the ambient environment and the image that is rendered (i.e., picked up) can be set. On the other hand, when the display property setting mode is “MANUAL”, the mode is set to the display mode selected by the user. Accordingly, the image can be displayed in the display mode desired by the user.

### C. Third Embodiment

Next, the third embodiment will be explained.

In the first and second embodiments, the CPU 10 analyzes the image data to estimate “what image is displayed”, and sets the display mode based on the estimated result, or sets to the display mode selected by the user. In the third embodiment, a battery remaining amount is further monitored, and when the battery remaining amount becomes less than a predetermined value, the display mode is automatically switched to “POWER SAVING”.

C-1. Configuration of Digital Camera 1

FIG. 9 is a block diagram showing the general electrical outline configuration of a digital camera 1 realizing the imaging apparatus of the present invention. The digital camera 1 basically has the same configuration as the digital camera 1 shown in FIG. 1, except that it includes a power circuit 20 (power supply means) and a power voltage detection circuit 21 (power supply capability judgment means) in addition to the configuration of the block diagram shown in FIG. 1A. Note that the same codes are provided to the same configuration sections as those shown in FIG. 1A.

The power circuit 20, including a battery 201 and a voltage control section for controlling the voltage of the battery 201 to a predetermined voltage, functions as supplying the predetermined voltage controlled by the voltage control section to each section of the digital camera 1. The power voltage detection circuit 21 functions as detecting the battery remaining amount of the battery 201 by acquiring the voltage value of the battery 201. The voltage value of the battery 201 detected by the power voltage detection circuit 21 is sent to the CPU 10 (change means).

C-2. Operation of Digital Camera 1

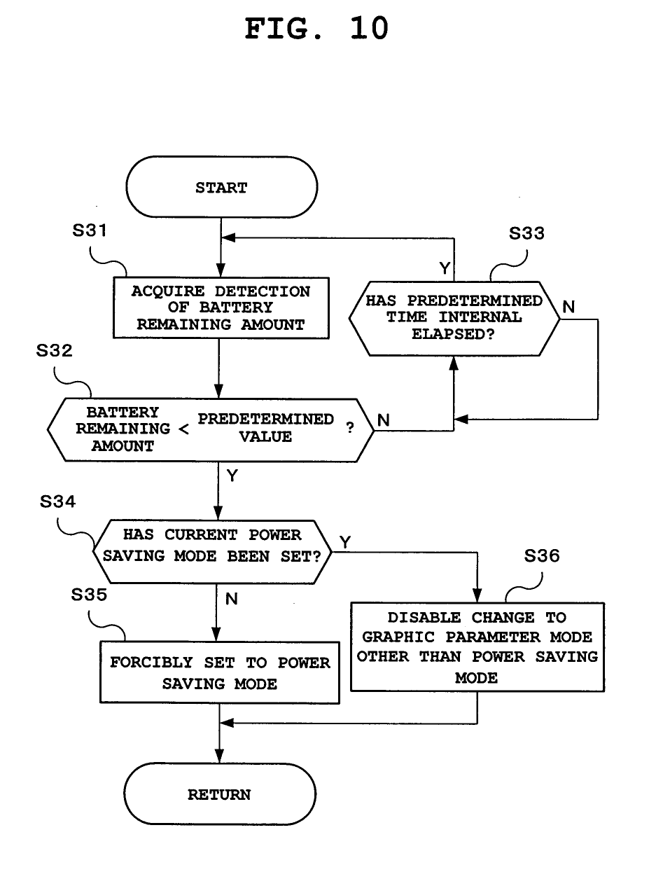

The operation of the digital camera 1 according to the third embodiment will be explained in accordance with the flowchart in FIG. 10. This operation is performed in parallel with the operation as shown in FIG. 2 or FIG. 8.

First, at Step S31, the CPU 10 causes the power voltage circuit 21 to detect the battery remaining amount of the battery 201 and acquires the detected battery remaining amount from the power voltage circuit 21.

Next, at Step S32, the CPU 10 judges whether the acquired battery remaining amount is smaller than a predetermined value. If judged at Step S32 that the acquired battery remaining amount is not smaller than the predetermined value, the CPU 10 advances to Step S33 where the CPU 10 judges whether a certain time interval has elapsed. If judged at Step S33 that the certain time interval has not elapsed, the CPU 10 stays at Step S33 until the certain time interval has elapsed, and if judged that the certain time interval has elapsed, the CPU 10 returns to Step S31. This enables acquiring the battery remaining amount of the battery 201 at certain time intervals.

On the other hand, if judged at Step S32 that the acquired battery remaining amount is smaller than the predetermined value, the CPU 10 advances to Step S34, where the CPU 10 judges whether “POWER SAVING” has been set as the current display mode. If judged at Step S34 that “POWER SAVING” has not been set as the current display mode, the CPU 10 advances to Step S35 where the CPU 10 switches the display mode and sets it to “POWER SAVING”. The “POWER SAVING” display mode which has been set will not be changed unless the battery remaining amount becomes larger than the predetermined value through charging of the battery 201.

Next, according to POWER SAVING which has been set at Step S34, the CPU 10 acquires the LV at Step S7 in FIG. 2, and adjusts the parameters on the illumination brightness of the illumination section 16 and the brightness level based on the LV acquired at Step S8.

Note that instead of switching all graphic parameters for the display mode which is currently set to the graphic parameters for POWER SAVING, only the setting of the graphic parameter on the illumination brightness may be changed from the display mode which is currently set to “POWER SAVING”. In that case, even after Step S35, setting of the display mode can be changed to that of a display mode other than POWER SAVING by automatic setting or manual setting by the user, except that setting of the graphic parameter on the illumination brightness will not be changed. This is because as the illumination brightness value of the illumination section 16 increases, the power consumption increases, and thus a load is not applied to the battery if only the illumination brightness value is suppressed.

On the other hand, if judged at Step S34 that “POWER SAVING” has been set as the current display mode, the CPU 10 advances to Step S36 where the CPU 10 disables setting change to a display mode other than “POWER SAVING”. The disenabling of setting change is cancelled when the battery remaining amount becomes larger than the predetermined value through charging of the battery. Note that even after Step S36, the display property setting mode may be changed to a display mode other than “POWER SAVING” by “AUTOMATIC” or “MANUAL”, except that setting of illumination brightness is not changed.

As described above, in the third embodiment, when the battery remaining amount of the battery 201 becomes smaller than the predetermined value, the display mode is set to “POWER SAVING” and the setting cannot be changed to another display mode. Accordingly, the power consumption can be suppressed by suppressing illumination brightness of the illumination section 16, and a very small battery remaining amount can be used efficiently. Accordingly, operating time of the digital camera can be made longer.

### D. Fourth Embodiment

Next, the fourth embodiment will be explained.

In the third embodiment, when the battery remaining amount of the battery 201 becomes smaller than the predetermined amount, the display mode is set to “POWER SAVING”. In the fourth embodiment, however, power consumption is suppressed while staying in the display mode which is currently set in stead of switching the setting of the display mode to “POWER SAVING”.

D-1. Configuration of Digital Camera 1

The fourth embodiment also realizes the imaging apparatus using the digital camera 1 with the same configuration as that shown in FIG. 9 except for the different graphic parameter tables for each display mode stored in the memory 12. In the fourth embodiment, among various types of the graphic parameters stored in the graphic parameter table for each display mode, only the illumination brightness is stored respectively for each stage of the battery remaining amount.

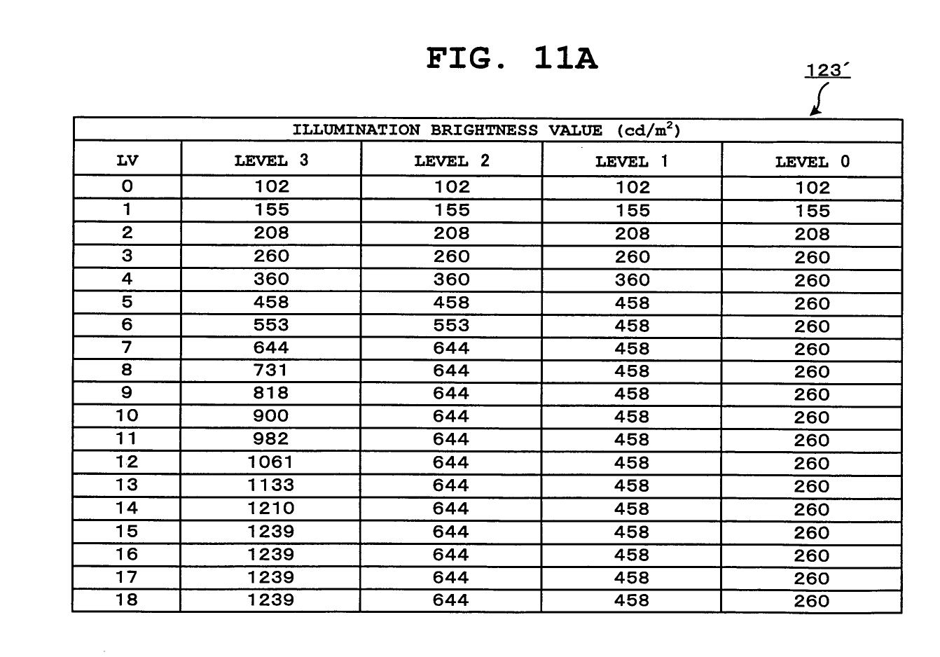

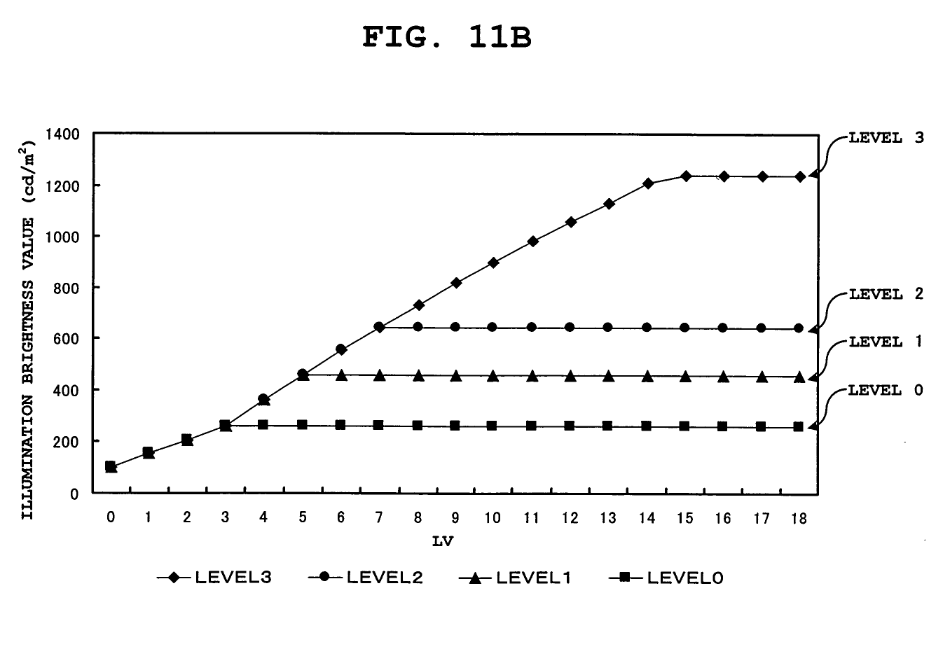

FIG. 11A shows the table 123′ showing the graphic parameters on the illumination brightness out of the graphic parameter table 123 when the display mode is “VIVID”. FIG. 11B is a diagram showing a relational graph between the parameters on the illumination brightness and the LV. Note that since the graphic parameters on other than the illumination brightness are the same as those shown in FIG. 5, they are omitted.

Referring to FIG. 11A, it is understood that the illumination brightness is stored in accordance with multiple levels (stages): LEVEL 3, LEVEL 2, LEVEL 1 and LEVEL 0.

The LEVEL indicates the battery remaining amount. LEVEL 3 corresponds to the case where the battery remaining amount of the battery 201 is sufficient, and LEVEL 0 corresponds to the case where there is no substantial battery remaining amount of the battery 201 (that is, the battery is almost running out). Furthermore, LEVEL 2 corresponds to the case where the battery remaining amount is the half of the full state, and LEVEL 1 corresponds to the case where the battery remaining amount is considerably small. In other words, the battery remaining amount decreases in the order of LEVEL 3->LEVEL 2->LEVEL 1->LEVEL 0.

Referring to FIG. 11A, when the battery remaining amount is LEVEL 3, the maximum illumination brightness is set to 1239 (cd/m²). In addition, when the battery remaining amount is LEVEL 2, the maximum illumination brightness is set to the illumination brightness at LV 7 which is lower than LV 15, that is, 644 (cd/m²). In addition, when the battery remaining amount is LEVEL 1, the maximum illumination brightness is set to the illumination brightness at LV 5 which is lower than LV 7, that is, 458 (cd/m²). In addition, when the battery remaining amount is LEVEL 0, the maximum illumination brightness is set to the illumination brightness at LV 3 which is lower than LV 5, that is, 260 (cd/m²). Note that explanation has been given on the graphic parameter table when the display mode is “VIVID”. In other display modes, the maximum graphic parameters on the illumination brightness are also set smaller in accordance with scarcity (i.e., smallness) of the battery remaining amount.

D-2. Operation of Digital Camera 1

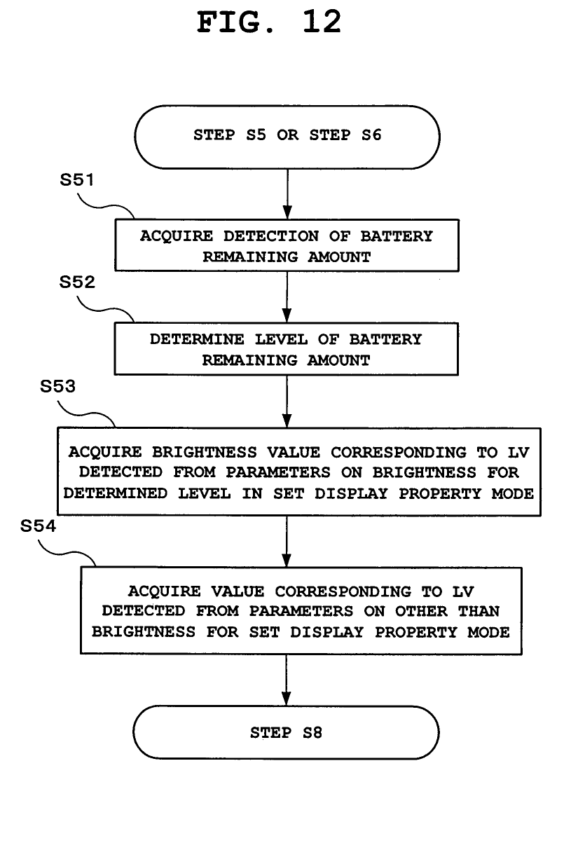

Hereinafter, the operation of the digital camera 1 according to the fourth embodiment will be explained referring to the flowchart in FIG. 12. When the CPU 10 sets the display mode in Step S5 or Step S6 in FIG. 2, or in Step S16 or Step S17 in FIG. 8, the CPU 10 advances to Step S51 in FIG. 12, where the CPU 10 causes the power voltage circuit 21 to detect the battery remaining amount of the battery 201, and acquires the detected battery remaining amount from the power voltage circuit 21.

Next, at Step S52, the CPU 10 determines the level of the battery remaining amount based on the detected battery remaining amount. In that case, the CPU 10 judges what level the current battery remaining amount corresponds to out of the four levels: LEVEL 3, LEVEL 2, LEVEL 1 and LEVEL 0. Note that the number of levels may instead be 2, or 5 or more.

Next, at Step S53, the CPU 10 acquires the brightness value corresponding to the LV detected at Step S2 in FIG. 2 or Step S13 in FIG. 8 from the graphic parameters on the illumination brightness for the LEVEL that has been determined for the display mode that has been set.

For example, when the display mode is set to “VIVID” and the level is determined as LEVEL 2, the CPU 10 acquires the brightness value corresponding to the detected LV from the parameters on the illumination brightness for LEVEL 2 in FIG. 11.

Next, at Step S54, the CPU 10 acquires the values corresponding to the detected LV among the graphic parameters on other than the illumination brightness (that is, on the brightness level, the contrast level, and the saturation level), respectively, and advances to Step S8 in FIG. 2 or Step S19 in FIG. 8. This enables automatic adjustment of the illumination brightness of the illumination section 16 based on the acquired brightness value and displays the image based on the image data acquired at Step S1 according to the acquired individual parameters on the brightness level, the contrast level and the saturation level.

This enables making the illumination brightness value smaller depending on the current battery remaining amount without changing the display mode that has been set. Therefore, the power consumption can be suppressed and a very small battery remaining amount can be used efficiently. Accordingly, the operating time of the digital camera can be made longer.

As described above, in the fourth embodiment, not only the graphic parameters on the illumination brightness are provided for each level for each display mode depending on the battery remaining amount of the battery 201, but also the maximum illumination brightness values are suppressed more for the LEVEL where the battery remaining amount is smaller. Therefore, the power consumption can be suppressed by suppressing the illumination brightness and a very small battery remaining amount can be used efficiently. Accordingly, the operating time of the digital camera can be made longer.

Note that instead of having multiple parameters on the brightness for each level, only one parameter on the brightness may be provided (i.e., a parameter for LEVEL 3 is provided), and the maximum brightness value may be set depending on scarcity of the current battery remaining amount as in the first and second embodiments.

### E. Modifications

Following modifications are possible for each of the embodiments as described above.

(1) In each of the embodiments described above, the graphic parameter tables storing multiple types of graphic parameters for each display mode are provided. However, graphic parameter tables storing display-mode specific graphic parameters may be provided for each type of the graphic parameters. Specifically, multiple types of graphic parameters such as on the brightness value, the brightness level and the contrast level are stored for each display mode such as REAL and DYNAMIC in the above described embodiments. Instead, the display-mode specific graphic parameter may be stored for each type of graphic parameters such as on the brightness and the brightness level. An example thereof will be hereafter explained.

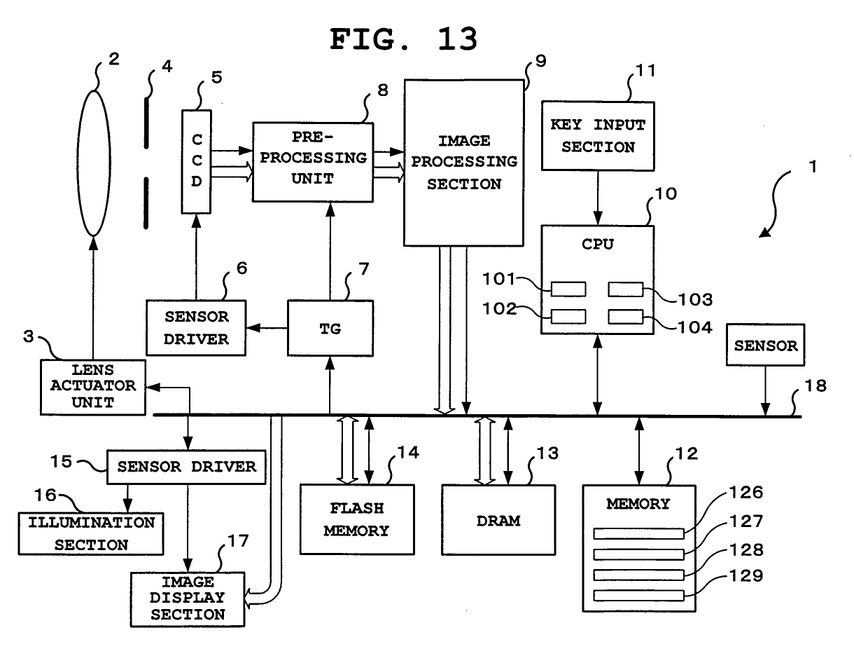

FIG. 13 is a block diagram showing the general electrical outline configuration of the digital camera 1 in Modification (1). Basically, the digital camera 1 has the same configuration as the digital camera 1 shown in FIG. 1, except that different graphic parameter tables are stored in the memory 12. Note that the same codes are provided to the same configuration sections as those shown in FIG. 1A.

The memory 12 in FIG. 13 includes a brightness parameter table 126 storing the parameters on the illumination brightness for each display mode, a brightness level parameter table 127 storing the parameters on the brightness level for each display mode, a contrast level parameter table 128 storing the parameters on the contrast level for each display mode, and a saturation level parameter table 129 storing the parameters on the saturation level for each display mode.

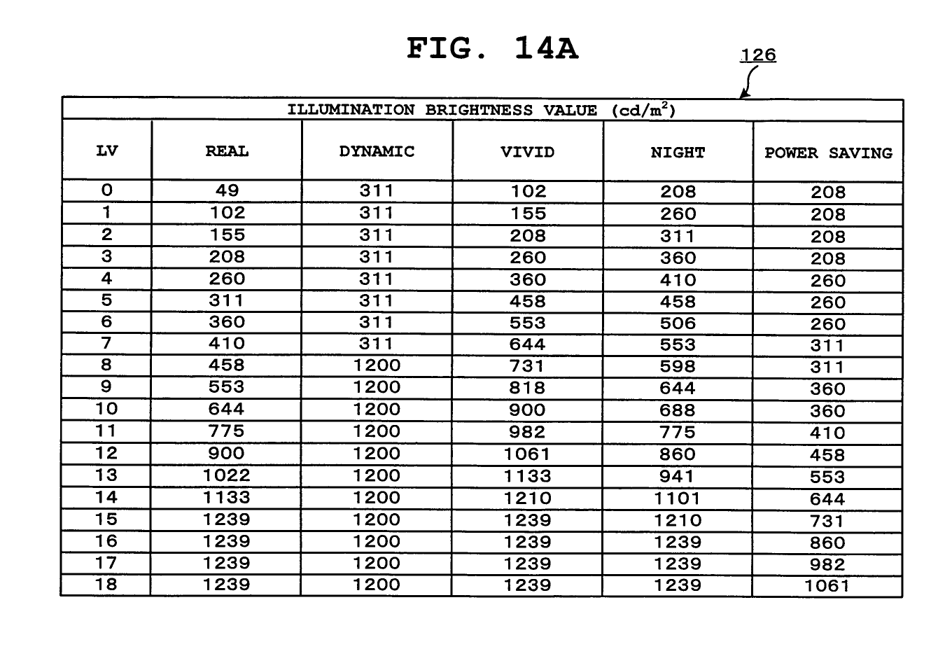

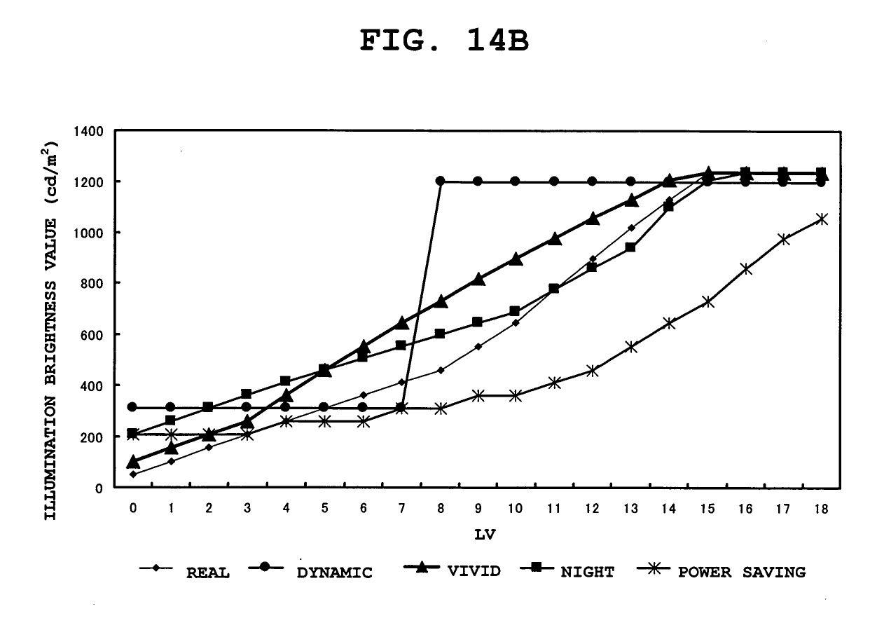

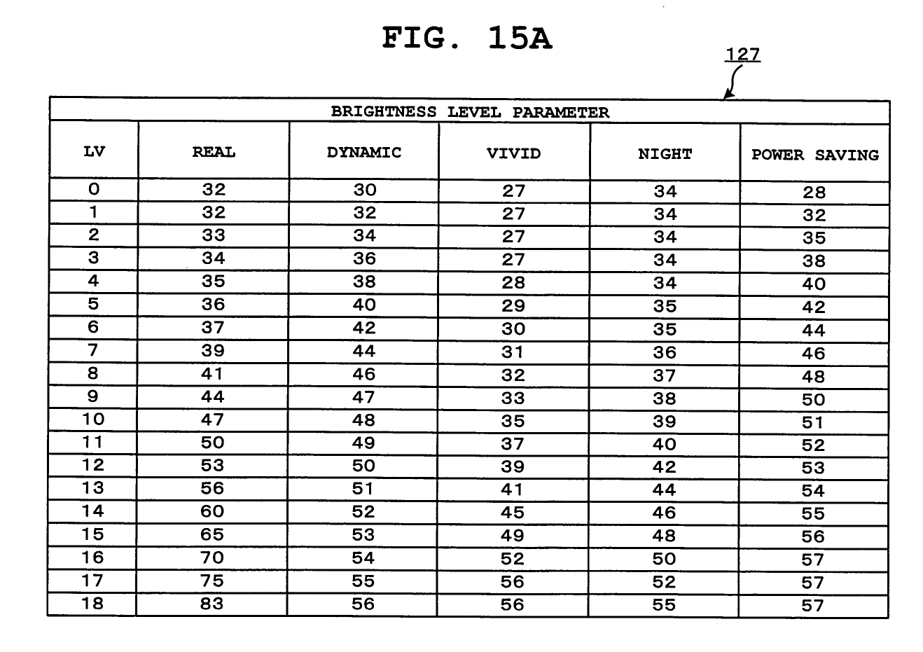

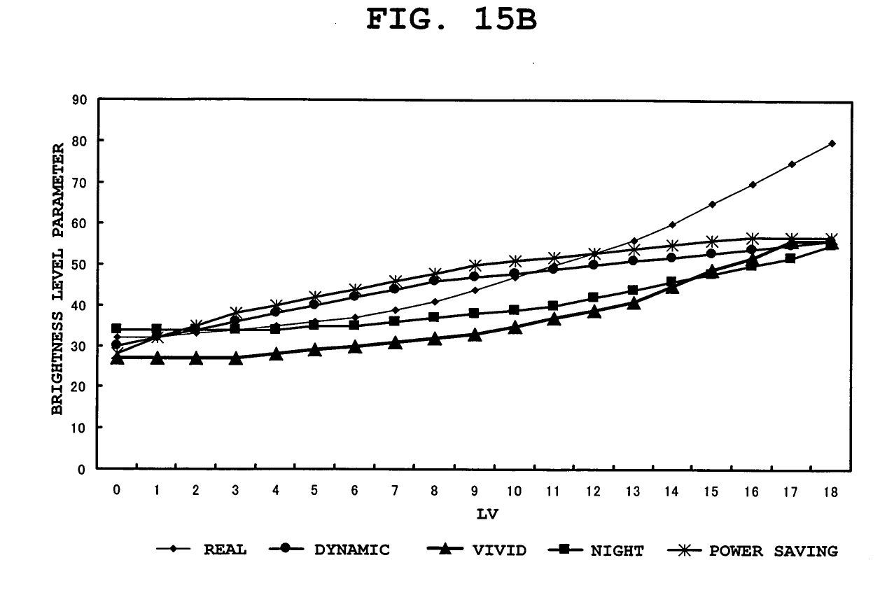

FIGS. 14A and 14B show the contents of the brightness parameter table 126 stored in the memory 12 and the relational graph between the LV based on the brightness parameter table and the illumination brightness for each display mode, respectively. FIGS. 15A and 15B show the contents of the brightness level parameter table 127 and the relational graph between the LV based on the brightness parameter table and the brightness level for each display mode, respectively.

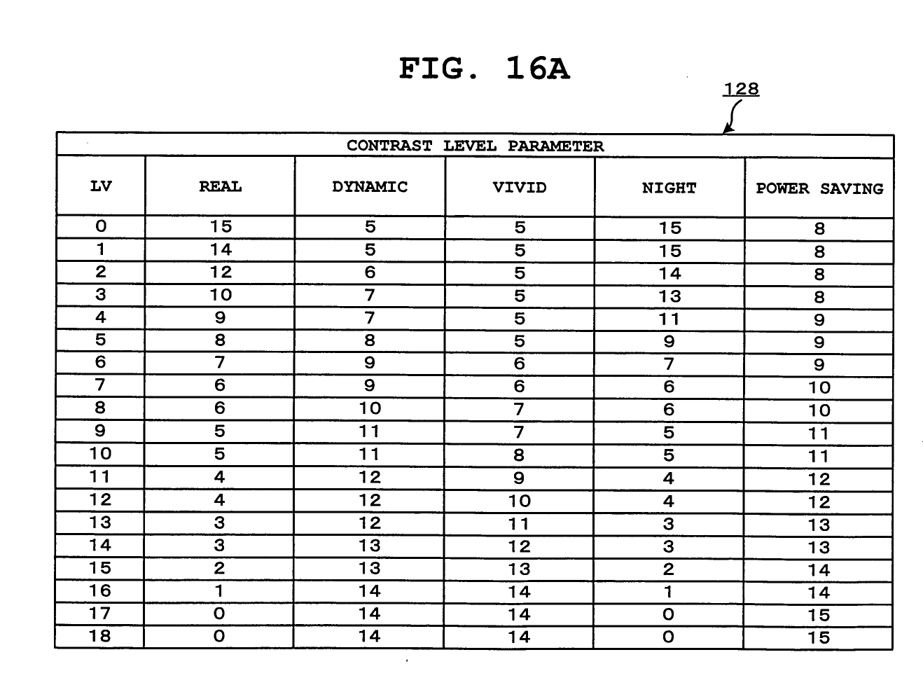

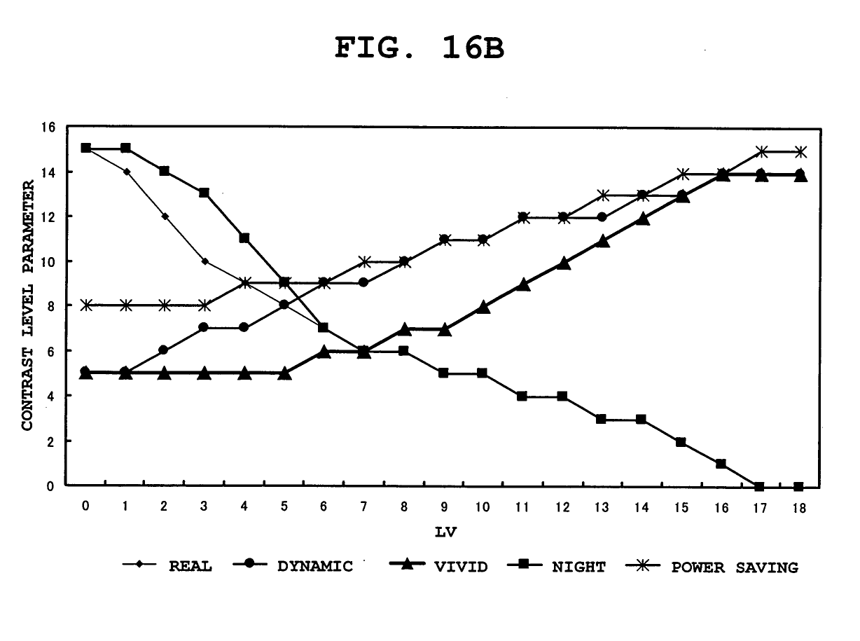

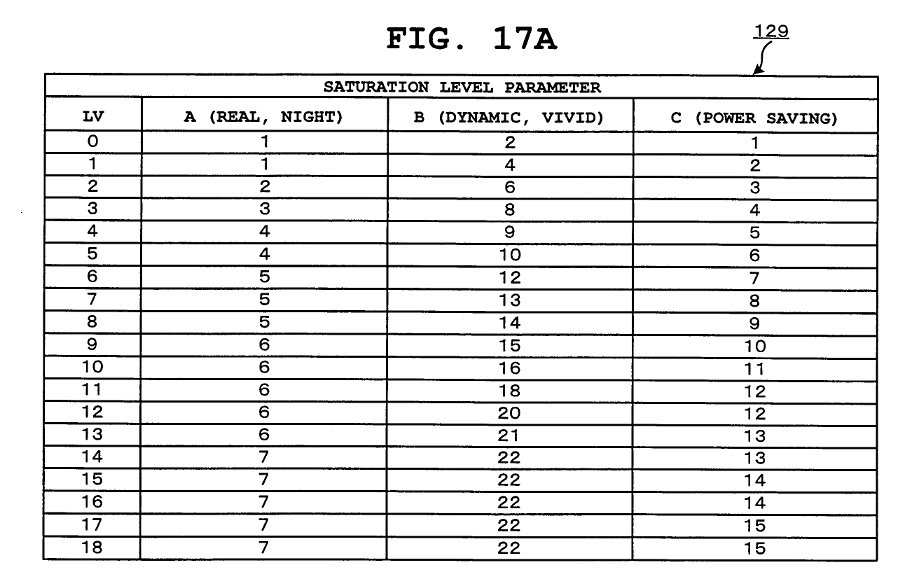

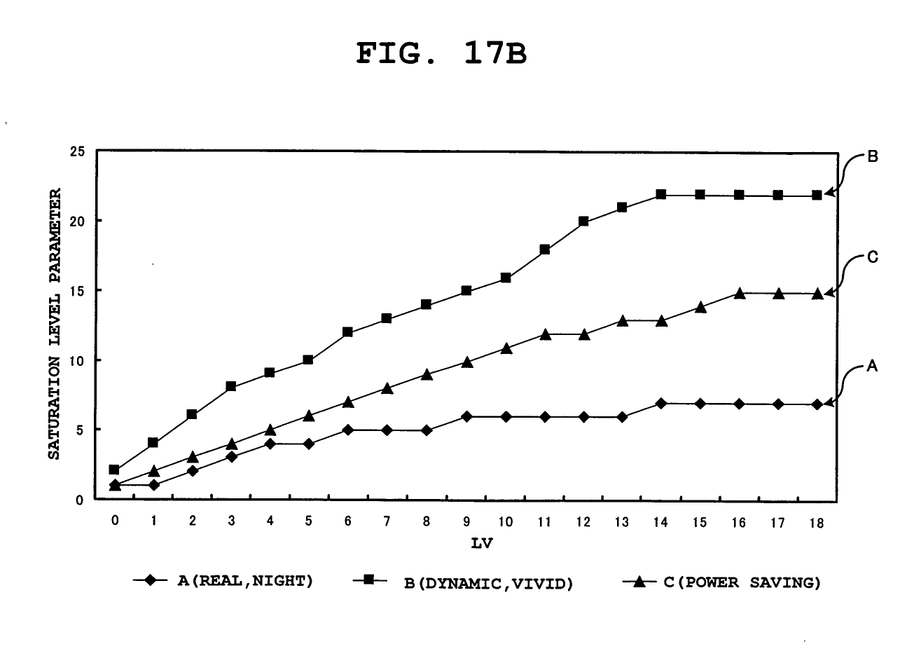

Furthermore, FIGS. 16A and 16B show the contents of the contrast level parameter table 126 and the relational graph between the LV based on the contrast level parameter table and the contrast level for each display mode. FIGS. 17A and 17B show the contents of the contents of the saturation level parameter table 126 and the relational graph between the LV based on the saturation level parameter table and the saturation level for each display mode.

For example, referring to the brightness level parameter table 127 in FIG. 15A, it is seen that the parameters on the brightness level for each display mode shown in FIGS. 3A, 3B to FIGS. 7A, 7B are stored. Note that since the values stored in the brightness parameter table in FIG. 14A directly indicate the brightness value (that is, FIG. 14A shows the brightness level (cd/m²)), they are different from the values on the brightness for each display mode as shown in FIGS. 3A, 3B to FIGS. 7A, 7B.

Next, the CPU 10 acquires each graphic parameter on each type from the brightness parameter table 126, the brightness level parameter table 127, the contrast level parameter table 128, and the saturation level parameter table 129 (Step S7 in FIG. 2 and Step S18 in FIG. 8).

As described above, the tables storing the parameters on each type for each display mode are provided, which enables design change and customization by the user, compared to the case where the graphic parameter tables are provided for individual display modes. Furthermore, in the case where only substantially three patterns are prepared for the saturation level as shown in FIGS. 17A and 17B, it is possible to suppress the memory capacity more by storing the parameters for each type of the parameters than by providing graphic parameter tables for each display mode.

(2) In each of the embodiments described above, multiple graphic parameters such as on the illumination brightness UP, the illumination brightness DOWN, the brightness level, the contrast level and the like have been stored as the graphic parameters in the graphic parameter table. Instead, only the parameters on the illumination brightness UP and the illumination brightness DOWN may be stored and only the illumination brightness may be adjusted based on those parameters.

(3) In each of the embodiments described above, the display-mode specific graphic parameter table is stored in the memory 12, and the graphic parameter corresponding to the detected LV and the display mode that has been set is read out from the stored graphic parameter table. Instead, the graphic parameters may be calculated by operation based on the detected LV and the display mode that has been set.

(4) Furthermore, in each of the embodiments described above, face recognition processing may be used as another method of evaluating the image contents of the image data and estimating it. In that case, a “FLESH COLOR PRIORITY” display mode is provided as the display mode, and when a face is recognized by the face recognition processing, the “FLESH COLOR PRIORITY” display mode may be automatically selected. The point is any method that enables determining the image contents is acceptable. In that case, display modes and graphic parameters corresponding to the determined image contents are provided.

(5) In addition, in each of the embodiments described above, the illumination brightness is automatically adjusted based on the graphic parameters corresponding to the detected LV and the display mode that has been set, and the image based on the image data is displayed according to the brightness level, the contrast level, the saturation level, and the sharpness level. However, in the case where finder brightness has been manually adjusted by operation of a finder brightness adjustment button by the user, the display brightness may be adjusted based on the manual adjustment. In that case, processing is performed based on the graphic parameters other than the parameters related to display illumination.

(6) In addition, in the first embodiment as described above, the LV is detected every time an image data is picked up by the CCD 5, and the display property is automatically adjusted based on the detected LV and the display mode that has been set. Instead, the LV value may be detected from the image data that has been picked up at certain time intervals (such as every 1 second, every 30 frames, etc.), and the display property may be automatically adjusted based on the detected LV. Similarly, in the second embodiment, the LV values are also detected for each imaging cycle of the CCD 5, or each frame cycle (i.e., cycle for displaying frames), or each display cycle of a still image, and the display property is automatically adjusted based on the detected LV value. Instead, the LV may be detected at certain time intervals (for example, every 1 second, every 30 frames, etc.) and the display property may be automatically adjusted based thereon.

(7) In addition, in each of the embodiments described above, explanation was given on the imaging apparatus. Instead, a display apparatus for displaying an image or other screen may also be used. In that case, an optical sensor 18 need be provided to the display apparatus.

(8) In addition, in each of the embodiments described above, as a method of analyzing the image data for estimation, the type of the file formats of the image data to be displayed, or the document data or the drawing data that are the source thereof may be determined and the display mode may be automatically set depending on the type of the determined file format.

(9) In addition, although multiple so-called display modes are provided in each of the embodiments described above, the so called display modes need not be provided. In that case, only one graphic parameter table is stored. Also in this case, unnatural colors and low-definition display can be prevented while ambient brightness is taken into consideration.

(10) Furthermore, any embodiment realized by arbitrarily combining the modifications (1) to (9) as described above is possible.

(11) Furthermore, although the image display section 17 is described as a device that requires illumination by the illumination section 16 in each of the embodiments described above, the image display section 17 is not limited to this. For example, a self-luminous type display device such as an organic EL, a plasma display, a surface-conduction electron-emitter display, etc. may be applied. In that case, in place of the illumination brightness of the illumination section 16, luminous brightness (display brightness) of the device itself may be adjusted.

Finally, although explanation was given on the case where the display control apparatus according to the invention is applied to the digital camera 1 as an image display apparatus and imaging apparatus in each of the above embodiments, appreciation thereof is not limited to the embodiments described above. The point is it can be applied to any device which is capable of displaying an image.

Furthermore, although the computer program product of the display control apparatus which is a preferred embodiment of the invention is stored in the memory (for example, ROM, etc.) of the display control apparatus, this processing program is stored on a computer-readable medium and should also be protected in the case of manufacturing, selling, etc. of only the program. In that case, the method of protecting the program with a patent will be realized by the form of the computer-readable medium on which the computer program product is stored.

While the present invention has been described with reference to the preferred embodiments, it is intended that the invention be not limited by any of the details of the description therein but includes all the embodiments which fall within the scope of the appended claims.

What is claimed is:

1. A display control apparatus comprising:
a display section;
a brightness value acquisition section which acquires a brightness value of an ambient environment;
a first adjustment section which adjusts a display brightness of the display section in accordance with the brightness value acquired by the brightness value acquisition section;
a second adjustment section which adjusts a parameter related to a display property of the display section in accordance with the brightness value acquired by the brightness value acquisition section; and
a display control section which controls the display section so as to display an object to be displayed based on the display brightness adjusted by the first adjustment section and the parameter adjusted by the second adjustment section.

2. The display control apparatus according to claim 1 having a plurality of types of display property modes, further comprising:
a selection section which selects an arbitrary display property mode from these display property modes; and
a first adjustment control section which controls the second adjustment section so as to adjust the parameter based on adjustment contents corresponding to the display property mode selected by the selection section.

3. The display control apparatus according to claim 2, the object of which being an image, further comprising:
an estimation section which estimates contents of the image based on color components of the image, and
a first selection control section which controls the selection section so as to select an arbitrary display property mode from the plurality of types of display property modes based on a result estimated by the estimation section.

4. The display control apparatus according to claim 2, further comprising:
a power supply section;
a power supply capability judgment section which judges a power supply capability of the power supply section; and
a change section which changes the display property mode selected by the selection section in accordance with a result of judgment by the power supply capability judgment section.

5. The display control apparatus according to claim 1, further comprising:
a power supply section;
a power supply capability judgment section which judges a power supply capability of the power supply section; and
a second adjustment control section which controls an adjustment by at least one of the first adjustment section and the second adjustment section in accordance with a result of judgment by the poser supply capability judgment section in addition to the brightness value acquired by the brightness value acquisition section.

6. The display control apparatus according to claim 1, further comprising:
an imaging section, and
a first acquisition control section which controls the brightness value acquisition section so as to acquire the brightness value of the ambient environment based on brightness components of the image picked up by the imaging section.

7. The display control apparatus according to claim 1, further comprising:
an optical sensor, and
a second acquisition control section which controls the brightness value acquisition section so as to acquire the brightness value of the ambient environment based on the brightness value acquired by the optical sensor.

8. The display control apparatus according to claim 1, further comprising:
an illumination section which illuminates the display section, and
a third adjustment control section which controls the first adjustment section so as to control a degree of illumination by the illumination section in accordance with the brightness value of the ambient environment acquired by the brightness value acquisition section.

9. The display control apparatus according to claim 1, with the parameter related to the display property being defined as at least one of a brightness level, a contrast level and a saturation level.

10. The display control apparatus according to claim 1, further comprising:
a storage section which associates the brightness value with the parameter and stores them; and
a fourth adjustment control section which controls the second adjustment section so as to read out the corresponding parameter from the storage section in accordance with the brightness value acquired by the brightness value acquisition section and control it.

11. A display control method for displaying an object to be displayed to a display section comprising:
a brightness value acquisition step for acquiring a brightness value of an ambient environment;
a first adjustment step for adjusting a display brightness of the display section in accordance with the brightness value acquired by the brightness value acquisition step;
a second adjustment step for adjusting a parameter related to a display property of the display section in accordance with the brightness value acquired by the brightness value acquisition step; and
a display control step for controlling the display section so as to display the object to be displayed based on the display brightness adjusted by the first adjustment step and the parameter adjusted by the second adjustment step.

12. The display control method according to claim 11, having a plurality of types of display property modes, further comprising:
a selection step for selecting an arbitrary display property mode from these display property modes; and
a first adjustment control step for controlling the second adjustment step so as to adjust the parameter based on adjustment contents corresponding to the display property mode selected by the selection step.

13. The display control method according to claim 12, the object of which being an image, further comprising:
an estimation step for estimating contents of the image based on color components of the image; and
a first selection control step for controlling the selection step so as to select an arbitrary display property mode from the plurality of types of display property modes based on a result estimated by the estimation step.

14. The display control method according to claim 12, further comprising:
a power supply step;
a power supply capability judgment step for judging a power supply capability of the power supply step; and
a change step for changing the display property mode selected by the selection step in accordance with a result of judgment by the power supply capability judgment step.

15. The display control method according to claim 11, further comprising:
a power supply step;
a power supply capability judgment step for judging a power supply capability of the power supply step; and
a second adjustment control step for controlling an adjustment by at least one of the first adjustment step and the second adjustment step in accordance with a result of judgment by the poser supply capability judgment step in addition to the brightness value acquired by the brightness value acquisition step.

16. A computer-readable storage medium having a display control program stored thereon that is executable by a computer for displaying an object to be displayed to a display section, comprising:
a brightness value acquisition step for acquiring a brightness value of an ambient environment;
a first adjustment step for adjusting a display brightness of the display section in accordance with the brightness value acquired by the brightness value acquisition step;
a second adjustment step for adjusting a parameter related to a display property of the display section in accordance with the brightness value acquired by the brightness value acquisition step; and
a display control step for controlling the display section so as to display the object to be displayed based on the display brightness adjusted by the first adjustment step and the parameter adjusted by the second adjustment step.

17. The computer-readable storage medium having a display control program stored thereon that is executable by a computer according to claim 16, having a plurality of types of display property modes, further comprising:
a selection step for selecting an arbitrary display property mode from these display property modes; and
a first adjustment control step for controlling the second adjustment step so as to adjust the parameter based on adjustment contents corresponding to the display property mode selected by the selection step.

18. The computer-readable storage medium having a display control program stored thereon that is executable by a computer according to claim 17, the object of which being an image, further comprising:
an estimation step for estimating contents of the image based on color components of the image, and
a first selection control step for controlling the selection step so as to select an arbitrary display property mode from the plurality of types of display property modes based on a result estimated by the estimation step.

19. The computer-readable storage medium having a display control program stored thereon that is executable by a computer according to claim 17, further comprising:
a power supply step;
a power supply capability judgment step for judging a power supply capability of the power supply step; and
a change step for changing the display property mode selected by the selection step in accordance with a result of judgment by the power supply capability judgment step.

20. The computer-readable storage medium having a display control program stored thereon that is executable by a computer according to claim 16, further comprising:
a power supply step;
a power supply capability judgment step for judging a power supply capability of the power supply step; and
a second adjustment control step for controlling an adjustment by at least one of the first adjustment step and the second adjustment step in accordance with a result of judgment by the poser supply capability judgment step in addition to the brightness value acquired by the brightness value acquisition step.

21. A display control apparatus comprising:
a display means;
a brightness value acquisition means for acquiring a brightness value of an ambient environment;
a first adjustment means for adjusting a display brightness of the display means in accordance with the brightness value acquired by the brightness value acquisition means;
a second adjustment means for adjusting a parameter related to a display property of the display means in accordance with the brightness value acquired by the brightness value acquisition means; and
a display control means for controlling the display means so as to display an object to be displayed based on the display brightness adjusted by the first adjustment means and the parameter adjusted by the second adjustment means.
